(19) United States
(12) Patent Application Publication
(10) Pub. No.: US 2023/0227002 A1
(43) Pub. Date: Jul. 20, 2023

(54) Biometric Steering Wheel and Biometric Based Vehicle Safety System

(71) Applicant: Jairus Smith, Corona, NY (US)

(72) Inventor: Jairus Smith, Corona, NY (US)

(21) Appl. No.: 17/741,685

(22) Filed: May 11, 2022

Related U.S. Application Data
(60) Provisional application No. 63/299,450, filed on Jan. 14, 2022.

(51) Int. Cl. B60R 25/25; B60R 25/04; B60R 25/06; B60R 25/40

(52) U.S. Cl. CPC B60R 25/252; B60R 25/255; B60R 25/04; B60R 25/06; B60R 25/403

(57) ABSTRACT

The present invention relates to a biometric steering wheel including biometric sensors for scanning biometrics of a user and a display screen for displaying biometric authentication status. The invention also discloses a biometric based anti-theft and anti-carjacking system for a vehicle using the biometric steering wheel. An on-board controller is coupled to an ECU of the vehicle and is configured to enable the ignition and gear system of the vehicle upon a successful biometric authentication and to disable the ignition and gear system of the vehicle upon an unsuccessful biometric authentication. The on-board controller stores registered biometrics for comparison that are used for authentication of the present biometrics. The steering wheel can be configured to use and ‘read’ fingerprints, retinas, DNA samples, and/or face recognition as a biometric.

### CROSS-REFERENCE TO RELATED APPLICATION

The present application claims priority to, and the benefit of, U.S. Provisional Application No. 63/299,450, which was filed on Jan. 14, 2022 and is incorporated herein by reference in its entirety.

### FIELD OF THE INVENTION

The present invention relates generally to the field of anti-theft devices for vehicle security. More specifically, the present invention relates to an improved steering wheel equipped with biometric sensors for allowing only authorized users to operate the vehicle. The improved steering wheel of the present invention features a display screen that conveniently shows whether a person is granted access to operate the vehicle. The invention provides a theft security system in order to prevent the vehicles from being stolen. Accordingly, the present disclosure makes specific reference thereto. Nonetheless, it is to be appreciated that aspects of the present invention are also equally applicable to other like applications, devices, and methods of manufacture.

### BACKGROUND

By way of background, vehicle theft and carjacking issues are quite common around the world. Usually, key based access mechanisms are used to access and operate vehicles. Key fobs and other smart key alternatives are also used to easily access and operate most motor vehicles. However, if the key or key fob used for accessing vehicles are stolen, then an unauthorized user can easily access and operate the vehicle. Also, if the key or key fob is mistakenly left in the vehicle, then theft cannot be prevented. Thieves can easily steal the motor vehicle (i.e. carjack the vehicle) with mere access to the key or key fob of the vehicle, without being scrutinized for any kind of authorization.

Also, thieves or other unauthorized users can easily break the vehicle lock system and can operate the vehicle using key alternatives. The standard locks of the vehicle can be easily broken and thieves may be able to start the vehicle without needing a key. Individuals may be unable to prevent unauthorized and malicious users from operating, carjacking, and/or stealing the vehicles.

Individuals may be insecure and may worry about the vehicle being stolen while leaving the vehicle at any place. Currently, there is no means to prevent unauthorized access to vehicles and to prevent vehicle theft issues as well.

Therefore, there exists a long-felt need in the art for a steering wheel that prevents theft issues by authenticating biometrics. There is also a long-felt need in the art for an anti-theft security system that prevents unauthorized access to the vehicles. Additionally, there is a long-felt need in the art for a vehicle security system that prevents any malicious users from stealing the vehicles. Moreover, there is a long-felt need in the art for a vehicle security system that prevents unauthorized access to vehicles in case the key/key fob of vehicles are lost, stolen, or carjacked. Further, there is a long-felt need in the art for a vehicle security system that prevents vehicle owners from being worried about unauthorized access of vehicles and ensures the safety of vehicles against theft issues. Furthermore, there is a long-felt need in the art for a vehicle security system that enables the users to leave their vehicle, at any place, without worrying about it getting stolen. Finally, there is a long-felt need in the art for a vehicle security system that ensures peace of mind to vehicle owners by preventing any unauthorized users from accessing or operating their vehicles.

The subject matter disclosed and claimed herein, in one embodiment thereof, comprises a biometric steering wheel. The biometric steering wheel comprising a plurality of biometric sensors disposed on spokes of the steering wheel, the biometric sensors are configured to sense at least one biometric of a user, an on-board controller for receiving sensed biometric from the sensors, the on-board controller is further configured to authenticate received biometric, and a display device for displaying biometric authentication results. The on-board controller is also configured to disable the ignition and gear system of the vehicle in which the steering wheel is deployed when biometric authentication fails, and to enable the ignition and gear system of the vehicle when biometric authentication is successful.

In this manner, the novel steering wheel device of the present invention accomplishes all of the forgoing objectives, and provides a relatively safe, easy, and convenient solution to prevent unauthorized users from accessing and operating vehicles, and also prevents vehicle theft and carjacking issues. The improved steering wheel of the present invention provides additional security, as it eliminates access to vehicles by mere access to the key or key fob and considers biometric authentication methods to provide access and operation of vehicles to authorized and registered users. With this, the improved steering wheel ensures only authorized and registered users can access and operate vehicles. The improved steering wheel device improves security of vehicles and provides peace of mind to the vehicle owners while leaving their vehicles unattended.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a biometric steering wheel. The biometric steering wheel comprising a plurality of biometric sensors disposed on spokes of the steering wheel, the biometric sensors are configured to sense at least one biometric of a user, an on-board controller for receiving sensed biometric from the sensors, the on-board controller is further configured to authenticate received biometric, and a display device for displaying biometric authentication results. The on-board controller is also configured to disable the ignition and gear system of the vehicle in which the steering wheel is deployed when biometric authentication fails, and to enable the ignition and gear system of the vehicle when biometric authentication is successful.

In yet another embodiment, the biometric steering wheel has recesses or cut-outs for accommodating biometric sensors, and the on-board controller stores registered, authenticated biometrics and compares received biometrics with the stored biometrics for authentication.

In yet another embodiment, the on-board controller is disposed in a dashboard of the vehicle, and the biometric sensors include one or more of fingerprint sensors, retina sensors, face recognizers, and DNA analyzers.

In yet another embodiment, the steering wheel is configured to transmit a notification to a vehicle owner on failed authentication of biometrics.

In yet another embodiment, an anti-theft biometric safety system for a vehicle is disclosed. The system includes a biometric steering wheel and an on-board controller. The biometric steering wheel includes a plurality of biometric sensors for sensing at least one biometric of a user, the on-board controller includes a processor for performing comparison of the sensed biometric with registered biometrics wherein the registered biometrics are stored in an internal memory of the on-board controller. The user is successfully authenticated when the sensed biometric completely matches with at least one of the registered biometrics for enabling the ignition and gear system of the vehicle, thereby allowing the user to start and operate the vehicle only after a successful authentication.

In yet another embodiment, the system includes a display device for displaying a message indicating successful authentication. In yet another embodiment, the system disables the ignition and gear system of the vehicle upon an unsuccessful authentication.

In yet another embodiment, a method for enabling the ignition of a vehicle only for authenticated users is disclosed. The method includes the steps of providing a biometric steering wheel, the steering wheel includes a plurality of biometric sensors and a display screen; receiving, by an on-board controller, biometrics scanned by biometric sensors; determining, by the on-board controller, authentication of the received biometrics; displaying, on the display screen, a message indicating successful authentication or unsuccessful authentication; and, enabling the ignition of the vehicle upon determination of successful authentication of biometrics.

In yet another embodiment, the determination is performed by comparison of the received biometrics with a plurality of stored biometrics.

In yet another embodiment, a biometric steering wheel for a vehicle is disclosed. The biometric steering wheel includes biometric sensing areas disposed on a rim of the steering wheel, the biometric sensing areas are configured to scan biometrics of a user, a display screen for displaying results of authentication of the scanned biometrics, the user can adjust his or her hands in different positions on the steering wheel for the biometric sensing areas to recognize biometrics.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a biometric steering wheel of the present invention in accordance with the disclosed architecture;

FIG. 2 illustrates an exploded view of the biometric steering wheel of FIG. 1 in accordance with the disclosed architecture;

FIG. 3 illustrates a connection diagram showing a biometric safety system for a vehicle using the biometric steering wheel of the present invention in accordance with the disclosed architecture;

FIG. 4 illustrates a block diagram showing essential components of an on-board controller used with the biometric steering wheel of the present invention in accordance with the disclosed architecture;

FIG. 5 illustrates a flow diagram depicting authentication process of scanned biometrics on the biometric steering wheel for allowing or disallowing operation of a vehicle in accordance with the disclosed architecture;

FIG. 6 illustrates a flow diagram depicting a process of registering and storing biometrics that are used for authentication of scanned biometrics for providing access to a vehicle in accordance with the disclosed architecture;

FIG. 7 illustrates a perspective view showing a successful authentication message on display device of the biometric steering wheel of the present invention in accordance with the disclosed architecture;

FIG. 8 illustrates a perspective view showing an unsuccessful authentication message on display device of the biometric steering wheel of the present invention in accordance with the disclosed architecture; and

FIG. 9 illustrates a perspective view of another embodiment of the biometric steering wheel of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a steering wheel that prevents theft issues by authenticating biometrics. There is also a long-felt need in the art for an anti-theft security system that prevents unauthorized access to the vehicles. Additionally, there is a long-felt need in the art for a vehicle security system that prevents any malicious users from stealing the vehicles. Moreover, there is a long-felt need in the art for a vehicle security system that prevents unauthorized access to vehicles in case the key/key fob of vehicles are lost, stolen, or carjacked. Further, there is a long-felt need in the art for a vehicle security system that prevents the vehicle owners from being worried about unauthorized access of vehicles and ensures the safety of vehicles against theft issues. Furthermore, there is a long-felt need in the art for a vehicle security system that enables the users to leave their vehicles, at any place, without worrying about it getting stolen. Finally, there is a long-felt need in the art for a vehicle security system that ensures peace of mind to the vehicle owners by preventing any unauthorized users from accessing or operating their vehicles.

The present invention, in one exemplary embodiment, is a novel anti-theft biometric safety system for a vehicle. The system includes a biometric steering wheel and an on-board controller. The biometric steering wheel includes a plurality of biometric sensors for sensing at least one biometric of a user, the on-board controller includes a processor for performing comparison of the sensed biometric with registered biometrics wherein the registered biometrics are stored in an internal memory of the on-board controller. The user is successfully authenticated when the sensed biometric completely matches with at least one of the registered biometrics for enabling the ignition and gear system of the vehicle, thereby allowing the user to start and operate the vehicle only after a successful authentication.

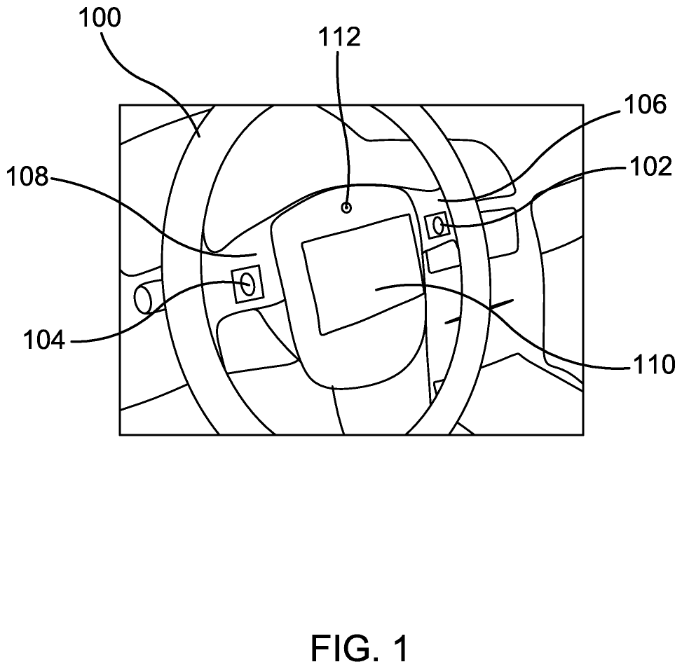

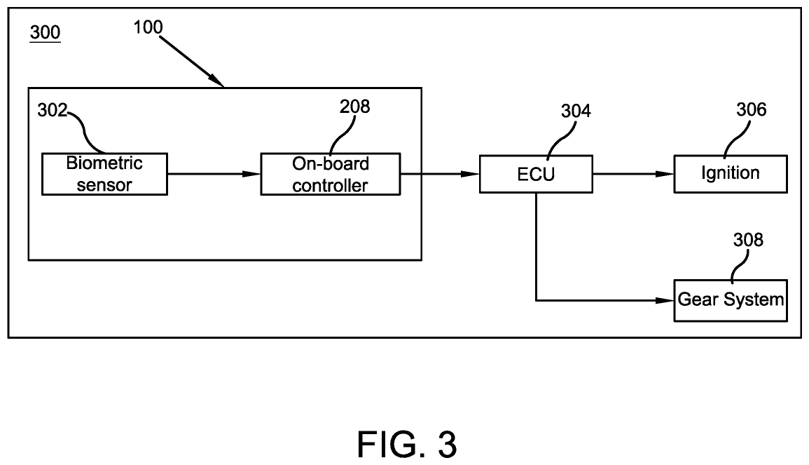

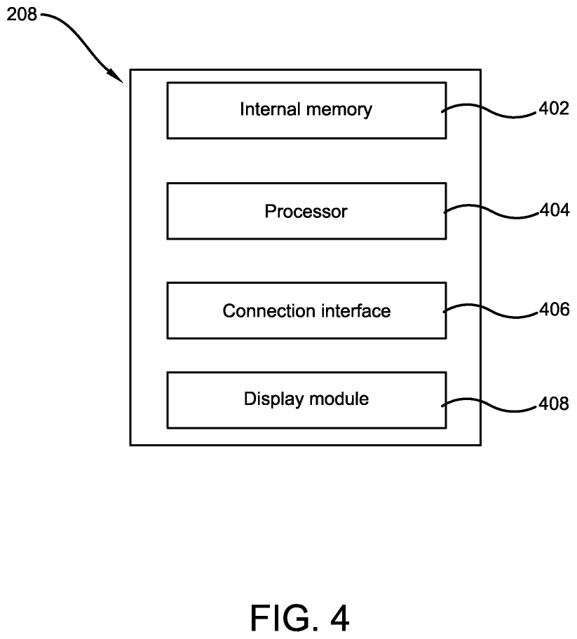

Referring initially to the drawings, FIG. 1 illustrates a perspective view of one potential embodiment of the biometric steering wheel 100 of the present invention in accordance with the disclosed architecture. The biometric steering wheel 100 of the present invention is an improved steering wheel equipped with biometric scanners that are configured to scan biometrics such as fingerprints. Other biometrics such as DNA detection or retinas may also be scanned by the biometric sensors. The fingerprints or other biometrics of a user are scanned by the biometric steering wheel 100 and are authenticated using an on-board controller as described in FIGS. 3, 4 & 5 for starting the vehicle. Accordingly, only authenticated individuals can start and operate the vehicle and thus, the biometric steering wheel 100 eliminates the worry of theft of the vehicle.

More specifically, the biometric steering wheel 100 of the present embodiment includes a pair of biometric sensors 102, 104 configured to scan fingerprints of a user. The sensors 102, 104 are disposed on the spokes 106, 108 of the biometric steering wheel 100, respectively. In use, a user is required to scan fingerprints on both the fingerprint sensors 102, 104 and when the scanned fingerprints are successfully authenticated, only then, the user can start and operate the vehicle. The fingerprint sensors 102, 104 scan ridges and valleys of the fingers of a user and the scanned fingerprints are transmitted to an on-board controller.

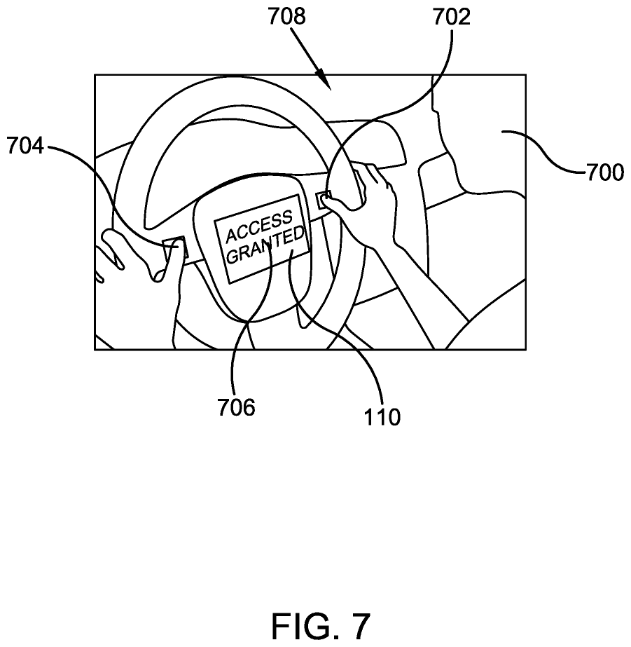

The biometric steering wheel 100 includes a display 110 configured to display results of authentication of scanned biometrics. The display 110 is a digital display and uses a built-in battery (not shown) for displaying results of authentication of biometrics as shown in FIGS. 7 & 8. The display 110 is also configured to display instructions for registration of the biometrics that are stored in the on-board controller and are used for comparison of sensed biometrics for authentication prior to operating the vehicle.

For providing additional biometric sensing capabilities, the biometric steering wheel 100 includes a retina sensor 112 for scanning a retina of a user. It should be noted that although the biometric steering wheel 100 of the present embodiment is shown to have both fingerprint sensors 102, 104 and retina sensor 112, but only the fingerprint sensors 102, 104 or retina sensors 112 may also work for authentication of a user. Also, additional biometric sensors like DNA analyzers, face recognition sensors may also be included in the biometric steering wheel 100 as per the requirement and preferences of the user and vehicle manufacturer. Any conventional biometric scanning can be included in the biometric steering wheel 100 and may work in a manner as described for fingerprint scanning in the present disclosure.

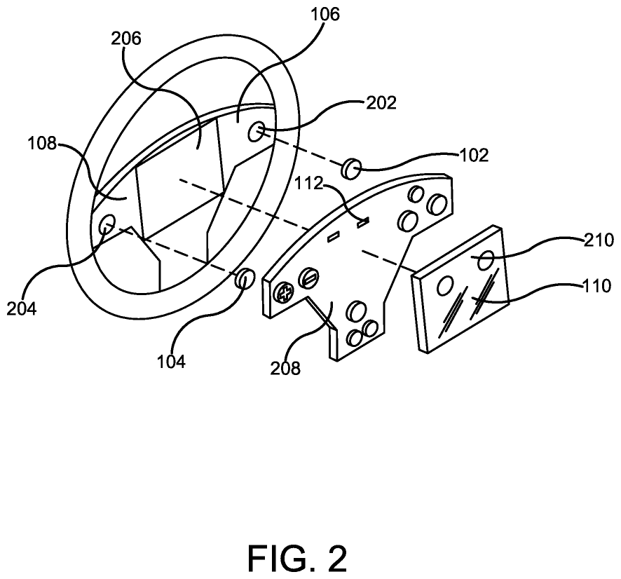

FIG. 2 illustrates an exploded view of the biometric steering wheel 100 of FIG. 1 in accordance with the disclosed architecture. As shown, the spoke 106 includes a first recess or cut-out 202 for receiving and positioning the fingerprint sensor 102 and similarly the spoke 108 includes a second recess or cut-out 204 for receiving and positioning the fingerprint sensor 104. The fingerprint sensors 102, 104 may be capacitive sensors, ultrasonic sensors with or without bioimpedance matching and live detection feature. The display 110 is integrated into the display slot 206 of the biometric steering wheel 100 and can be removed from the slot 206 for repairing jobs. The on-board controller 208 is disposed within the biometric steering wheel 100 and provides the control circuitry to authenticate the scanned biometrics for enabling and disabling the ignition and gear system of the vehicle as shown in FIG. 3.

The display 110 includes an integrated battery 210 for providing power to the display 110 when the vehicle is not operational. The battery 210 is configured to be recharged using the electric power of the vehicle in which the biometric steering wheel 100 is installed. The retina sensor 112 is integrated into the control board 208 and can be accessed from the biometric steering wheel 100 as described in FIG. 1.

FIG. 3 illustrates a connection diagram showing the biometric safety system 300 for a vehicle using the biometric steering wheel 100 of the present invention in accordance with the disclosed architecture. As shown, the biometric steering wheel 100 including biometric sensor 302 and the on-board controller 208, is connected to electronic control unit (ECU) 304 of the vehicle. The biometric sensor 302 can be any biometric sensor installed in the biometric steering wheel 100 of the present invention and includes one or both of the fingerprint sensors 102, 104 and retina sensor 112 of FIG. 1.

The biometric steering wheel 100 is connected to the ECU 304 of the vehicle which is responsible for enabling and disabling ignition system 306 and gear system 308 of the vehicle. When a biometric of a user is not authenticated by the on-board controller 208, the controller 208 provides an instruction signal to the ECU 304 for disabling both the ignition system 306 and the gear system 308 of the vehicle, thereby preventing a user from starting and operating the vehicle. When the biometric of a user is successfully authenticated by the on-board controller 208, the on- board controller 208 provides an instruction signal to the ECU 304 for enabling both the ignition system 306 and the gear system 308 of the vehicle, thereby allowing the user to start and operate the vehicle.

Although in the present embodiment, the on-board controller 208 is built-in within the biometric steering wheel 100, the on-board controller 208 can be disposed at any other location such as the dashboard within the vehicle and depends on the design and configuration of the vehicle in which the biometric steering wheel 100 is positioned.

FIG. 4 illustrates a block diagram showing essential components of the on-board controller 208 used with the biometric steering wheel 100 of the present invention in accordance with the disclosed architecture. The on-board controller 208 includes an internal memory 402 for storing the registered biometrics for operating the vehicle. When authorized biometrics are registered by vehicle owners for use with the biometric steering wheel 100, the biometrics are stored in the internal memory 402. The memory 402 may include ROM, RAM, Flash or NVRAM.

A processor 404 of the on-board controller 208 is configured to receive scanned biometrics from the biometric sensors positioned on the biometric steering wheel 100 and compare with the registered biometrics stored in the internal memory 402. Based on result of comparison, the processor 404 instructs the display module 408 to display a message on the display device 110 of the biometric steering wheel 100 as shown in FIGS. 7 & 8. The processor 404 can be a microprocessor or microcontroller and is configured to execute machine-readable instructions. The processor 404 can be a single chip applications processor and is further connected to internal memory 402 in any suitable manner. A communication interface 406 is configured to couple the on-board controller 208 with the biometric sensors disposed on the biometric steering wheel 100 and ECU of the vehicle.

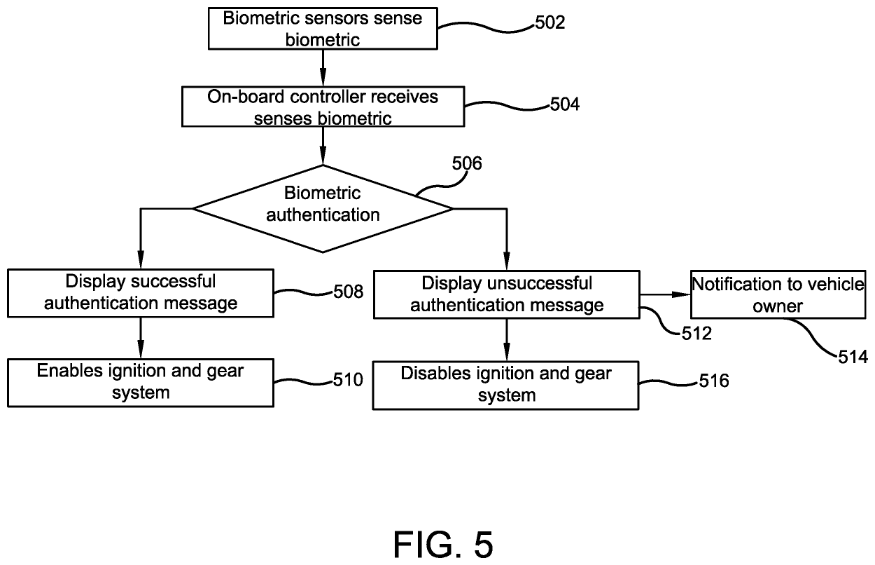

FIG. 5 illustrates a flow diagram depicting authentication process of scanned biometrics on the biometric steering wheel 100 for enabling or disabling operation of a vehicle in accordance with the disclosed architecture. As shown, initially, one or more biometric sensors sense or detect biometric parameters of a user (Step 502). It should be noted that the biometric sensors can be any of the fingerprint sensors, retina sensors, DNA analyzers, facial recognition scanners, and more. Once the biometrics are sensed by the sensor(s), the on-board controller 208 receives the sensed biometrics (Step 504). Thereafter, the on-board controller 208 performs an authentication of the received biometrics by comparing the received biometrics with the registered biometrics stored in the internal memory 402 of the on-board controller 208 (Step 506).

During the authentication process in step 506, if it is determined that the authentication is successful based on exact matching of the received biometrics with one or more of the registered biometrics, then the process moves to step 508, and a successful authentication message is displayed on the display device 110 of the biometric steering wheel 100 as shown in FIG. 7 indicating access grant of the vehicle. Along with the display of the successful authentication message, the ignition system and the gear system of the vehicle are enabled by the ECU of the vehicle (Step 510).

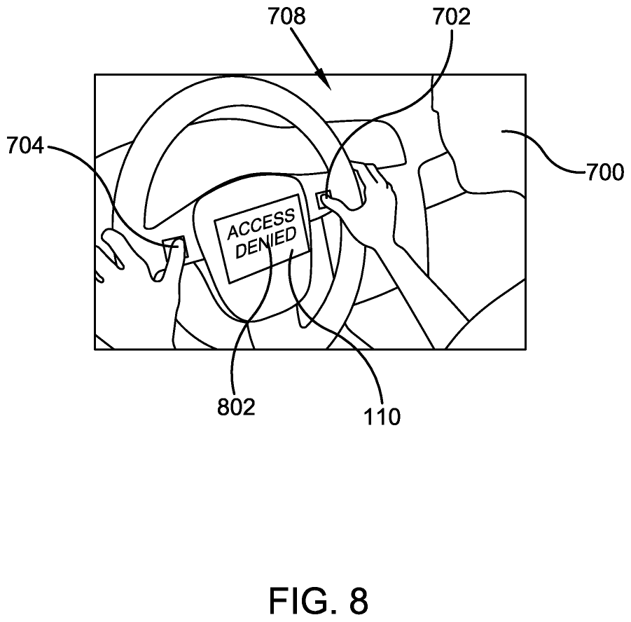

If during the authentication process in step 506, it is determined that the authentication is unsuccessful, then the process moves to step 512 and an unsuccessful authentication message is displayed on the display device 110 of the biometric steering wheel 100, or dashboard, as shown in FIG. 8. Further, a notification is sent to a handheld electronic device of a registered user such as the vehicle owner (Step 514) and the ignition system and the gear system of the vehicle are disabled by the ECU of the vehicle (Step 516).

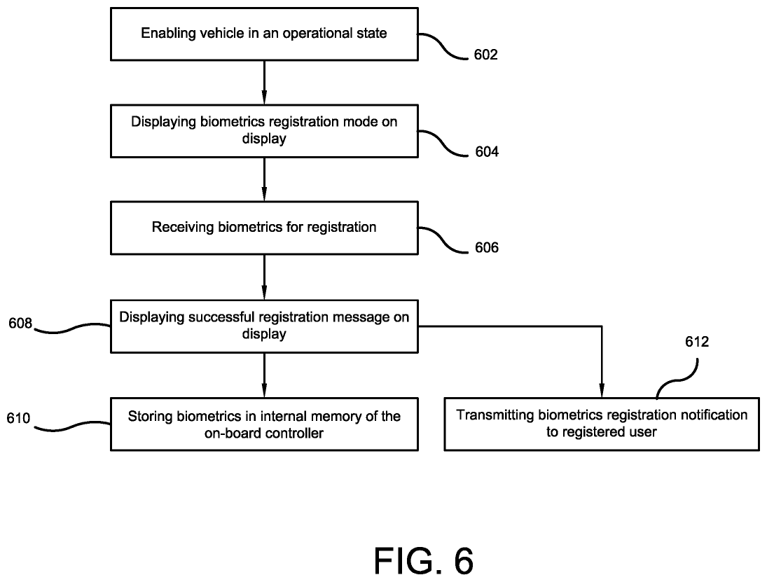

FIG. 6 illustrates a flow diagram depicting a process of registering and storing biometrics that are used for authentication of scanned biometrics for providing access to a vehicle in accordance with the disclosed architecture. It should be noted that the registration of biometrics can only take place when the vehicle is in an operational state thereby preventing users such as thieves or small children from registering biometrics when the vehicle is not in an operational state. Accordingly, for registering biometrics, the vehicle is enabled in an operational state (Step 602). Then, a biometrics registration mode is displayed on the display device 110 of the biometric steering wheel 100 prompting a user to scan biometrics (Step 604). Thereafter, the biometric sensors receive one or more biometrics for registration and authentication purposes (Step 606). A user may have to scan the biometrics a plurality of times for successful registration of the biometrics.

Once the biometrics are successfully scanned, a successful biometrics registration message is displayed on the display device 110 (Step 608). Then, the scanned biometrics are stored in the internal memory 210 of the on-board controller 208 and can be used for authentication to operate the vehicle as described in FIG.5 (Step 610). Simultaneously, a notification is sent to an authorized and paired handheld electronic device of the registered user of the vehicle such as a vehicle owner (Step 612).

It should be noted that in one embodiment of the present invention, the biometrics are successfully registered only when the registered user approves the notification sent by the biometric steering wheel 100.

FIG. 7 illustrates a perspective view showing successful authentication message on display device 110 of the biometric steering wheel 100 of the present invention in accordance with the disclosed architecture. As shown, when scanned biometrics such as fingerprints of the fingers 702, 704 of the user 700 are successfully scanned and authenticated by the biometric steering wheel 100, a successful authentication message “Access granted” 706 is displayed on the display device 110. Also, when the message 706 is displayed, the ignition system and gear system of the vehicle 708 are enabled allowing the user 700 to start and operate the vehicle 708.

FIG. 8 illustrates a perspective view showing unsuccessful authentication message on display device 110 of the biometric steering wheel 100 of the present invention in accordance with the disclosed architecture. When scanned biometrics such as fingerprints of the fingers 702, 704 of the user 700 are successfully scanned but are not authenticated by the biometric steering wheel 100, an unsuccessful authentication message 802 is displayed on the display device 110. Also, when the message 802 is displayed, the ignition system and gear system of the vehicle 708 are disabled and a notification is sent to the vehicle owner as described in FIG. 5.

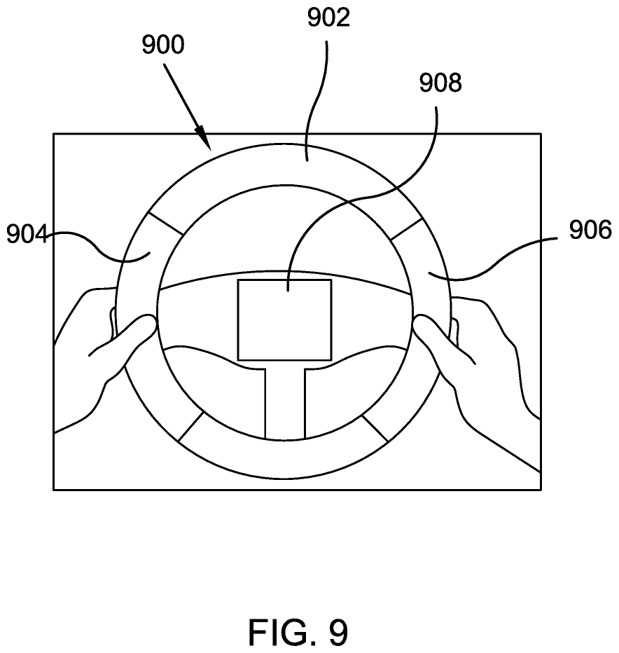

FIG. 9 illustrates a perspective view of another embodiment of the biometric steering wheel 100 of the present invention in accordance with the disclosed architecture. In the present embodiment, the steering wheel 900 has biometric sensing regions 904, 906 disposed on the rim 902 of the steering wheel 900. The biometric sensing regions 904, 906 have one or more biometric sensors disposed inside the rim and are configured to scan biometrics of a user.

A digital display 908 is configured to display biometric registration commands and biometric authentication result messages for notifying a user of the biometric authentication results.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “biometric steering wheel”, “steering wheel”, and “steering wheel with integrated biometric sensors” are interchangeable and refer to the biometric steering wheel 100 of the present invention.

Notwithstanding the forgoing, the biometric steering wheel 100 of the present invention can be of any suitable size and configuration as is known in the art without affecting the overall concept of the invention, provided that it accomplishes the above stated objectives. One of ordinary skill in the art will appreciate that the biometric steering wheel 100 as shown in the FIGS. are for illustrative purposes only, and that many other sizes and shapes of the biometric steering wheel 100 are well within the scope of the present disclosure. Although the dimensions of the biometric steering wheel 100 are important design parameters for user convenience, the biometric steering wheel 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A biometric steering wheel in a vehicle, the biometric steering wheel comprising:
at least one biometric sensor for sensing a present biometric;
a stored biometric; and
an on-board controller for comparing said present biometric with said stored biometric, wherein said on-board controller enables said vehicle when said present biometric matches said stored biometric, and further wherein said on-board controller disables said vehicle when said present biometric does not match said stored biometric.

2. The biometric steering wheel of claim 1, wherein said present biometric and said stored biometric are selected from a group consisting of a fingerprint, a retina, a DNA sample and a facial recognition.

3. The biometric steering wheel of claim 1, wherein said on-board controller is connected to a vehicle electronic control unit (ECU) and configured to enable or disable an ignition system and a gear system of the vehicle.

4. The biometric steering wheel of claim 1 further comprising a second biometric sensor for sensing another present biometric.

5. The biometric steering wheel of claim 4, wherein said at least one biometric sensor and said second biometric sensor are mounted on opposing spokes of said biometric steering wheel.

6. The biometric steering wheel of claim 4, wherein said at least one biometric sensor and said second biometric sensor each scan a fingerprint of a user of the vehicle.

7. The biometric steering wheel of claim 4, wherein said at least one biometric sensor scans a fingerprint of a user of the vehicle, and further wherein said second biometric sensor scans a retina of the user of the vehicle.

8. The biometric steering wheel of claim 1 further comprising a display configured to display results of said comparing said present biometric with said stored biometric.

9. The biometric steering wheel of claim 8 further comprising a built-in battery.

10. The biometric steering wheel of claim 8, wherein said display illustrates instructions for registration of said stored biometric.

11. An authentication method of scanning a biometric on a biometric steering wheel for enabling or disabling operation of a vehicle, the authentication method comprising the steps of:
storing a biometric of a user of the vehicle in a controller;
sensing a present biometric of the user of the vehicle;
comparing said stored biometric to said present biometric of the user;
authenticating said stored biometric with said present biometric with said controller;
enabling the vehicle operation when said present biometric is authenticated with said stored biometric; and
disabling the vehicle operation when said present biometric is not authenticated with said stored biometric.

12. The method of claim 11 further comprising a step of displaying a successful authentication message on a display device of said steering wheel when said present biometric is authenticated with said stored biometric.

13. The method of claim 12 further comprising a step of displaying an unsuccessful message on a display device of said steering wheel when said present biometric is not authenticated with said stored biometric.

14. The method of claim 11, wherein said stored biometric and said present biometric are selected from a group consisting of a fingerprint, a retina, a DNA sample and a facial recognition.

15. The method of claim 14, wherein said controller is connected to said vehicle electronic control unit (ECU), wherein said enabling the vehicle operation includes enabling an ignition system and a gear system, and further wherein said disabling the vehicle operation includes disabling said ignition system and said gear system.

16. The method of claim 15, wherein said biometric steering wheel comprises a built-in battery.

17. The method of claim 12, wherein said display illustrates instructions for registration of said stored biometric.

18. An authentication method of scanning a biometric on a biometric steering wheel for enabling or disabling operation of a vehicle, the authentication method comprising the steps of:
registering a biometric of a registered user of the vehicle in a controller;
sensing a present biometric of a present user of the vehicle;
comparing said registered biometric to said present biometric of said present user;
authenticating said registered biometric with said present biometric with said controller;
enabling the vehicle operation when said present biometric is authenticated with said registered biometric;
disabling the vehicle operation when said present biometric is not authenticated with said registered biometric;
wherein said controller is connected to said vehicle electronic control unit (ECU);
wherein said enabling the vehicle operation includes enabling at least one of an ignition system and a gear system; and
further wherein said disabling the vehicle operation includes disabling at least one of said ignition system and said gear system.

19. The method of claim 18 further comprising a step of sending a notification to a handheld electronic device of said registered user when said disabling the vehicle operation.

20. The method of claim 18, wherein said registered biometric and said present biometric are selected from a group consisting of a fingerprint, a retina, a DNA sample, and a facial recognition.
